(19) United States
(12) Patent Application Publication
(10) Pub. No.: US 2009/0008463 A1
(43) Pub. Date: Jan. 8, 2009

(54) CLIMATE ZONE CONTROL

(76) Inventors: Judah Benjamin Holland, Hallandale Beach, FL (US); Stewart Ronald Kaiser, Boyton Beach, FL (US)

Correspondence Address: LOTT & FRIEDLAND, P.A., P.O. BOX 141098, CORAL GABLES, FL, 33114-1098, US

(21) Appl. No.: 12/022,033

(22) Filed: Jan. 29, 2008

Related U.S. Application Data
(60) Provisional application No. 60/897,986, filed on Jan. 29, 2007.

(51) Int. Cl. G05D 23/00; F24F 7/007; F24F 3/00; G08B 21/00

(52) U.S. Cl. 236/51; 236/49.3; 165/205; 340/584

(57) ABSTRACT

The disclosed climate zone control system separates a building into separate climate zones, which allows a user to select the desired temperature of each zone. In a single zone, the climate zone controlling system controls the temperature of the single zone where an existing thermostat controls the temperature of air exiting an air handler and the remote thermostat controls the temperature of the designated zone of the building by controlling airflow from the vents. In a multiple zone system, there is a master thermostat that controls the air handler and multiple remote thermostats for multiple designated zones where the remote thermostat controls both the temperature and the airflow.

### PRIORITY

This application is being filed as a nonprovisional patent application claiming priority to provisional application Ser. No. 60/897,986 under 35 U.S.C. § 119.

### FIELD OF INVENTION

This invention involves the heating and cooling of a building by controlling the temperature of each room in a building, which conserves energy and protects natural resources. The climate in each zone is controlled by remote controlled wireless vents that open and close depending upon wireless signals received from a master thermostat or a remote thermostat located in the particular zone. In a single zone application, the remote thermostat controls the temperature of the single zone by controlling airflow whereas an existing thermostat controls the temperature of air exiting an air handler. In a multiple zone system, the existing thermostat is replaced by the master thermostat of the invention which performs all the functions of a conventional thermostat. The master thermostat has the ability to wirelessly communicate with either a single or multiple vents in its designated zone as well as multiple wireless remote thermostats throughout the facility. The master thermostat controls both the temperature through the air handler and the airflow in its zone through the wireless signal instructing the vents to open and close as needed.

### BACKGROUND OF THE INVENTION

There is currently an imminent need to conserve energy. The price of fossil fuels which are used to create the energy needed by all heating and cooling systems are increasing rapidly. There is also a movement to conserve the natural resources of the earth and to find alternative fuel supplies. Additionally, global warming has caused additional desires to reduce the consumption of fossil fuels as well as reducing emissions.

Heating and air conditioning systems are known. A standard system branches through out a building from an air handler to various rooms through duct work ending in vents in each room to distribute the airflow. The system is controlled by a thermostat at which the temperature is set. Once the predetermined temperature is reached at the thermostat, the system is shut off. If the temperature changes at the thermostat, the air handler is activated and the temperature at all rooms is affected by the system.

The problem with the standard system is the inability of the system to attain and maintain a desired and consistent temperature throughout the building. Most often, rooms closest to the air handler receive the greatest amount of airflow, while rooms furthest away from the air handler receive minimal airflow. This causes the various rooms of the building to be at different temperatures for a given predetermined temperature setting. When a dweller of the building needs to adjust the temperature of one room, he or she must adjust the temperature of all rooms. This can cause the rooms closest to the air handler to be overly hot or cold. This also consumes a considerable amount of wasted energy.

Additionally, individuals in the various rooms may desire the temperatures of each room to be different. Currently the most common way to accomplish this is to use a hard wired damper system which is a costly and an inefficient remedy. This is solving a micro problem by using a macro approach. Traditional known heating and cooling systems typically require the manual closing and opening of vents in addition to the regulation of the temperature at the main thermostat. Even with these modifications, it is very difficult to control or vary the temperature of one room. Other factors also affect the temperature of each room, such as the number of windows in the particular room, the weather, the amount of sunlight received by the room, the direction the room faces, the wind level, drafts in the room, etc.

### SUMMARY OF THE INVENTION

This invention involves the heating and cooling of a building by dividing the building into separate climate zones. Each zone with its own thermostat can be set to a different temperature. This allows multiple occupants of a home or office to be comfortable at different temperatures at the same time. This invention conserves energy and protects valuable natural resources. This invention is designed to provide a simple cost effective solution for the problem of excess airflow, such as too much cold air when the air condition is on or too much hot air when the heat is on. Additionally, the system can regulate temperature when there is not enough airflow, such as providing more cold or hot air as needed. The system is easy to install and operate. The system can be used with an existing air conditioning system and no additional hardware or wiring is required. There are three components to the system: (1) a master thermostat, (2) a wireless remote thermostat and (3) wireless vents with remote controlled louvers. There is no computerized interface between the master thermostat and the air handler. The term “master thermostat” as used herein refers to the thermostat of the invention that has the ability to control the air handler and wirelessly control the vents within a designated zone which are set to be controlled by the master thermostat. The master thermostat of the invention also has the ability to receive signals from the wireless remote thermostats. The term “remote thermostat” as used in respect of the invention refers to a thermostat that controls a designated zone and wirelessly communicates with vents in the designated zone and also has the capability to wirelessly communicate with the master thermostat. The term “vents” as used in respect of the invention refers to vents capable of receiving wireless instruction from either a master thermostat or a remote thermostat and opening or closing the louvers of the vent. The term “wireless” as used in respect of the invention refers to wireless protocols including conventional radio frequency (RF), BLUETOOTH™, ZIGBEE™, WIFI™ and other suitable wireless protocols that are known or that may become available. Reference herein to an “existing thermostat” means a conventional thermostat that is preexisting in a standard heating and cooling system.

The system can be used as: (1) a single zone system used to control excess airflow, such as too much cold air when the air condition is on or too much hot air when the heat is on; or (2) a multiple zone system used to regulate zones with excess airflow and/or not enough airflow, for example, not enough cold air when the air condition is on or not enough hot air when the heat is on. In a single zone scenario, the existing thermostat controls the temperature of air exiting an air handler. The wireless remote thermostat functions independently of the existing thermostat by controlling the vents located in its designated zone by sending a wireless signal instructing them to open or close as needed based on the set temperature. The primary function is to regulate excess airflow. When the set temperature is reached the vents will close. When more air is needed they will reopen. Multiple single zone systems can be used in one building without changing the existing thermostat.

In a multiple zone system the existing thermostat is replaced by the master thermostat of the invention which performs all the functions of a conventional thermostat. Additionally, the master thermostat has the ability to communicate with multiple vents sending instructions them to open or close. The master thermostat controls both the temperature via the air handler & airflow via the wireless vents in its zone. Additionally, the master thermostat will receive communication from the wireless remote thermostats located in other zones. As each zone reaches its set temperature the wireless remote thermostat sends a wireless signal to vents in its zone instructing to them to open or close. This will quickly redirect the airflow to the zones which have not yet reached their set temperatures. If a zone is not receiving enough airflow the wireless remote thermostat will instruct the vent to remain open, while simultaneously sending a wireless signal to the master thermostat instructing the system to remain on until the set temperature in its zone is reached. Once the master thermostat receives communications from all remote thermostats indicating that their respective temperatures have been reached, the air handler is turned off.

The invention is a climate zone controlling system that has the ability to work in conjunction with an air handler connected to duct work that distributes air to rooms of a building via the vent system comprising a master thermostat that controls the temperature of the air exiting from the air handler; and at least one remote thermostat that controls the temperature of at least one designated zone of a building. The master thermostat has the ability to control the air handler, and wirelessly control the vents within a designated zone which is set to be controlled by the master thermostat and the master thermostat has the ability to receive signals from the wireless remote thermostats. The remote thermostat is located in the designated zone and directs vents in the designated zone to open or close through transmission of a wireless signal so that the designated zone reaches the temperature selected by a user of the remote thermostat. The remote thermostat communicates with the master thermostat through transmission of a wireless signal when the air handler is required to remain on to reach said selected temperature. The vents are specialized vents that have the ability to receive wireless signals from the master or remote thermostat and open and close in response to the signal. The vents can be installed in one room or multiple rooms depending upon in which zones and rooms the temperature is desired to be controlled. The examples discussed herein primarily describe the use of the invention with a forced air system while in an air condition mode. The climate zoning system functions in a similar manner when in the heating mode.

Additionally disclosed is a climate zone controlling system that controls the temperature of selected zones by a wireless signal comprising an existing thermostat that controls the temperature of air exiting an air handler and at least one remote thermostat that controls the temperature of at least one designated zone of the building and one vent. The remote thermostat is located in the designated zone and directs the vents in the designated zone to open or close through a wireless signal so that the designated zone reaches the temperature selected by a user of the remote thermostat through control of excess airflow.

Also disclosed is a method of modifying the temperature of designated zones in a building comprising the steps of setting a master thermostat at a first desired temperature, wherein said master thermostat controls the air handler of said building and vents in a first designated zone of the building; setting a remote thermostat at a second desired temperature, wherein said remote thermostat is located in a second designated zone of the building and controls the vents in said second designated zone by directing them to open or close through the transmission of a wireless signal in order to obtain the second desired temperature. The remote thermostat communicates wirelessly to the master thermostat. Multiple remote thermostats may be used to control the temperature of multiple respective designated zones of the building.

The invention further includes a method of modifying the temperature of designated zones in a building by controlling excess airflow from an air handler comprising the steps of setting an existing thermostat at a first desired temperature, wherein the existing thermostat controls the air handler of said building; and setting a remote thermostat at a second desired temperature, wherein said remote thermostat is located in a designated zone of the building and controls the vents in said designated zone by directing them to open or close through the transmission of a wireless signal in order to obtain the second desired temperature through control of airflow to the designated zone. Multiple remote thermostats may be used to control the temperature of multiple respective designated zones of the building.

The invention also includes a single zone climate controlling system that controls an air handler comprising an existing thermostat that controls the temperature of the air exiting the air handler; and a remote thermostat that controls the temperature of the single zone of a building. The remote thermostat is located in said single zone and directs vents in the single zone to open or close through the transmission of a wireless signal so that the single zone reaches the temperature selected by a user of the remote thermostat through the control of the airflow. The invention also includes a multiple zone climate controlling system comprising a master thermostat that controls the air handler thereby controlling the temperature of the air exiting the air handler and wirelessly directs vents to open and close within a first designated zone; and at least one remote thermostat that controls the temperature selection of a second designated zone in said multiple zones wherein said remote thermostat is located in said second designated zone and directs vents in said second designated zone to open or close through the transmission of a wireless signal so that the second designated zone reaches the temperature selected by a user of the remote thermostat. The remote thermostat also communicates with the master thermostat through the transmission of a wireless signal when the air handler is required to remain on so that said zone reaches said selected temperature.

The climate zoning system separates a home, office or a building in general into separate climate zones. The invention allows a user to decide what rooms to heat or cool. The climate in each zone is controlled by remote controlled vents that open and close. The vents open and close depending upon wireless signals received from a remote thermostat located in the particular zone. The user will set the remote thermostat at a particular temperature. When the zone reaches that temperature, the vents will automatically open or close. Cold air or heat is redirected to zones where the user requires it or until remaining temperatures in all zones have been reached.

The climate control system is easy to implement with existing air conditioning and heating systems. No additional hardware or wiring is required other than the special vents and thermostats. The system is completely wireless. The communication between the remote thermostat and the master thermostat and the communication between the vents and the remote thermostat or the master thermostat is transmitted by a wireless signal. Each thermostat of the system communicates on its own channel. A unique channel of communication is established between each wireless thermostat and the vents in its designated zone by the use of dip switches, jumper switches, electronic logic or other similar mechanisms well known in the art for pairing wireless devices. The unique channels are set at the time of installation but can be changed as necessary. This unique channel prevents inadvertent opening or closing of vents by a remote thermostat in zones assigned to a different remote thermostat. In addition there is a separate wireless channel, set in similar fashion, for communication between the master thermostat and the remote thermostat(s). Accordingly, the system is extremely convenient to install, as no hardwiring of the system is required. Use of a remote thermostat allows every room or zone to have its own thermostat. The remote thermostat is battery operated and wireless and can be mounted or placed anywhere in the room. The remote thermostat has the ability to function independently in a single zone system allowing a user to control the excess airflow and thus temperature of the room by opening and closing the vent irrespective of the setting of the, existing thermostat. It can also be used in a multi zone system in conjunction with a master thermostat and vents.

The remote thermostat can be used in a single zone system to regulate airflow. The remote thermostat controls the vents located in the single designated zone by sending a wireless signal to the vents instructing them to open or close as needed. The primary function is to regulate excess airflow. The remote thermostat can also be used in a multi zone system. When the remote thermostat is used in conjunction with a master thermostat and vents, it has the ability to regulate both airflow and temperature in a multi zone system. If the designated zone is receiving too much airflow, the remote thermostat will instruct the vent to close. If the designated zone is not receiving enough airflow, the remote thermostat will instruct the vent to remain open, simultaneously sending a wireless signal to the master thermostat instructing the system to remain on until the set temperature is reached.

The master thermostat performs all the functions of a conventional thermostat. Additionally, it has the ability to communicate with the vents sending instructions to open or close, it can receive communication from the remote thermostats, and it can create multiple zones. In the multi-zone system, the master thermostat will control both the temperature and airflow in its zone. Additionally the master thermostat will receive communication from the remote thermostats located in other zones. If a zone is not receiving enough airflow, the remote thermostat will instruct the vents to remain open, simultaneously sending a wireless signal to the master thermostat which will instruct the system to maintain the air handler activated until the set temperature in all zones has been reached.

The climate zone control allows a user to leave unoccupied areas without heating and cooling, saving the user money on heating and cooling costs and unnecessary consumption of energy. The vents regulate airflow and room temperature through a remote signal received from the zone's thermostat. A battery operated wireless thermostat is placed anywhere in the zone or room. The thermostat is set at a desired temperature. The vents will receive a signal from the wireless thermostat instructing the vents to open or close as needed.

### BRIEF DESCRIPTION OF THE DRAWINGS

FIG. 1 is a perspective view of the system in a one story floor plan.

FIG. 2 is a perspective view of air being delivered to zone 1 rooms of the system in a one story floor plan.

FIG. 3 is a perspective view of air being delivered to zone 2 rooms of the system in a one story floor plan.

FIG. 4 is a perspective view of air being delivered to zone 3 rooms of the system in a one story floor plan.

FIG. 5 is a perspective view of the system in a two story building.

FIG. 6 is a perspective view of air being delivered to zone 1 rooms of the system in a two story building.

FIG. 7 is a perspective view of air being delivered to zone 2 rooms of the system in a two story building.

FIG. 8 is a perspective view of air being delivered to zone 3 rooms of the system in a two story building.

FIG. 9 is a perspective view of a single zone system.

FIG. 10 is the schematic for the master thermostat.

FIG. 11 is the schematic representation of interconnections between components of a multiple zone system.

### DETAILED DESCRIPTION OF THE PREFERRED EMBODIMENT

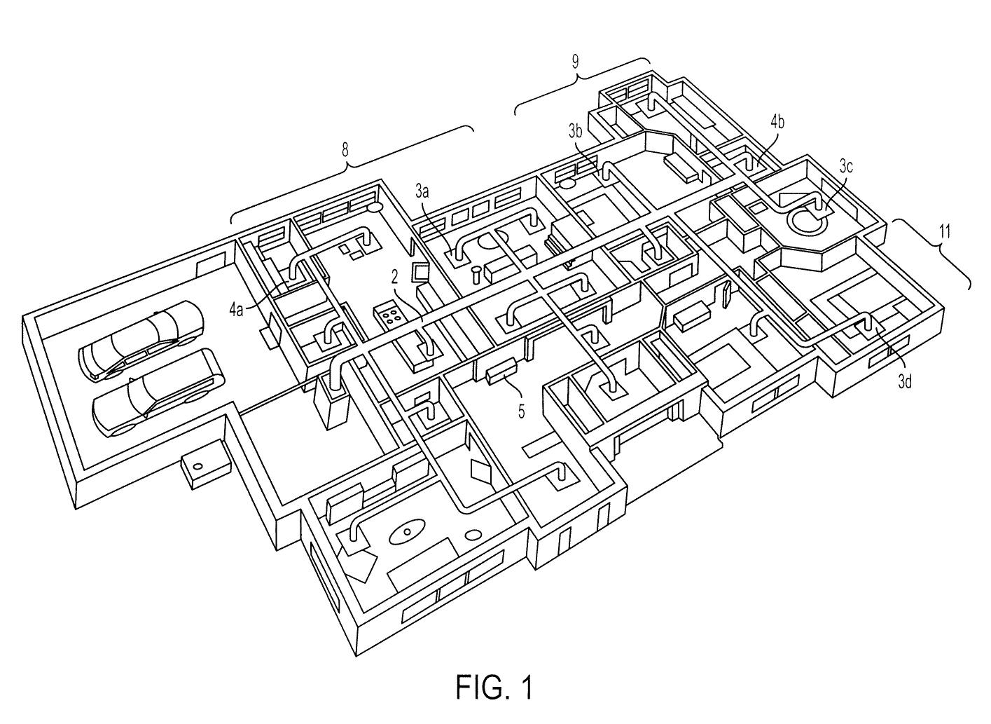

FIG. 1 is a perspective view of the system in a one story home as shown by way of a floor plan. The air handler 1 is connected to duct work 2 which carries the cooled or heated air to each room. The air enters the rooms by vents 3a, 3b, 3c and 3d. The master thermostat 5 allows a user to select a temperature and other settings of the air handler 1. The system, like all systems, may require discharge zones 4a and 4b to discharge excess air pressure when several vents shut simultaneously. The airflow system allows the home to be divided into separate climate zones 8, 9 and 11. Accordingly, the individuals in the home only use the air needed, when and where it is required.

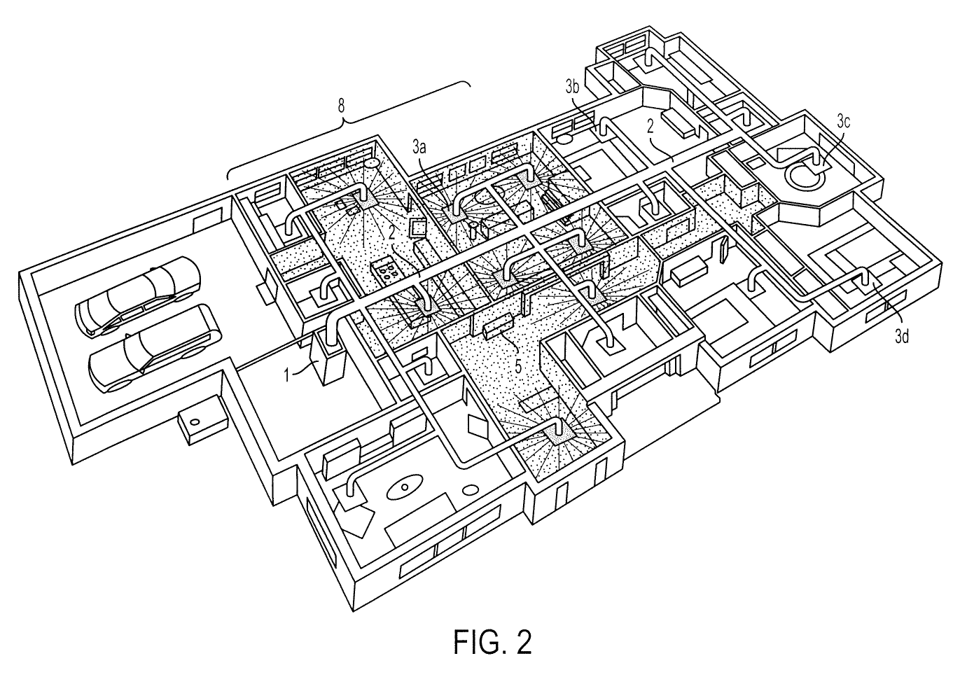

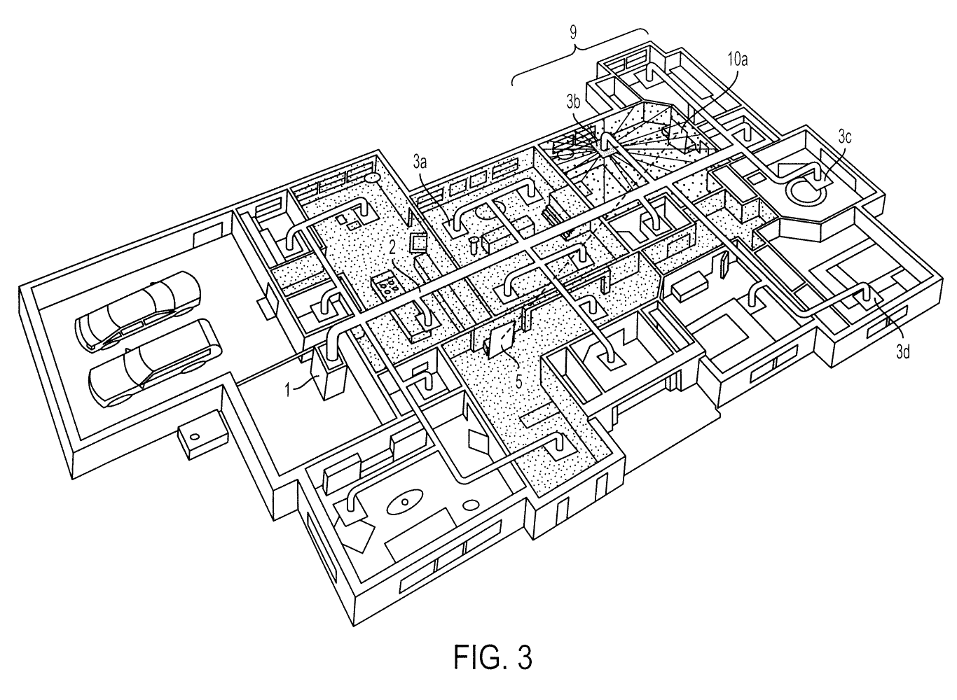

FIGS. 2, 3 and 4 demonstrate the airflow system by way of exemplary use of an embodiment of the system. As shown in FIG. 2, the individuals in the home can set the master thermostat 5 in zone 1 8 at 74°. The master thermostat then communicates to all the vents 3a in zone 1 8 as to whether the vents should be open or closed to reach the desired temperature. In the next step, as shown in FIG. 3, the selected temperature is reached in zone 1 8. At that point, the vents 3a in zone 1 8 close. In a traditional system, the air handler would shut down at this point. However, the remote thermostat 10a in a room in zone 2 9 sends a wireless instruction for the system to stay on, because the remote thermostat 10a is set at 72° and this zone has not reached the set temperature. Remote thermostats 10a are battery-operated wireless devices that can communicate with the vent in the selected room instructing them to open or close affecting the room temperature. The remote thermostat can wirelessly communicate with the master thermostat instructing it to continue to run if necessary. The air from the air handler 1 passes quickly through the duct work 2 to zone 2 9, because the vents 3a in zone 1 8 are now closed since zone 1 has reached the desired temperature. The vent 3b in zone 2 9 remains open until zone 2 9 reaches the set temperature.

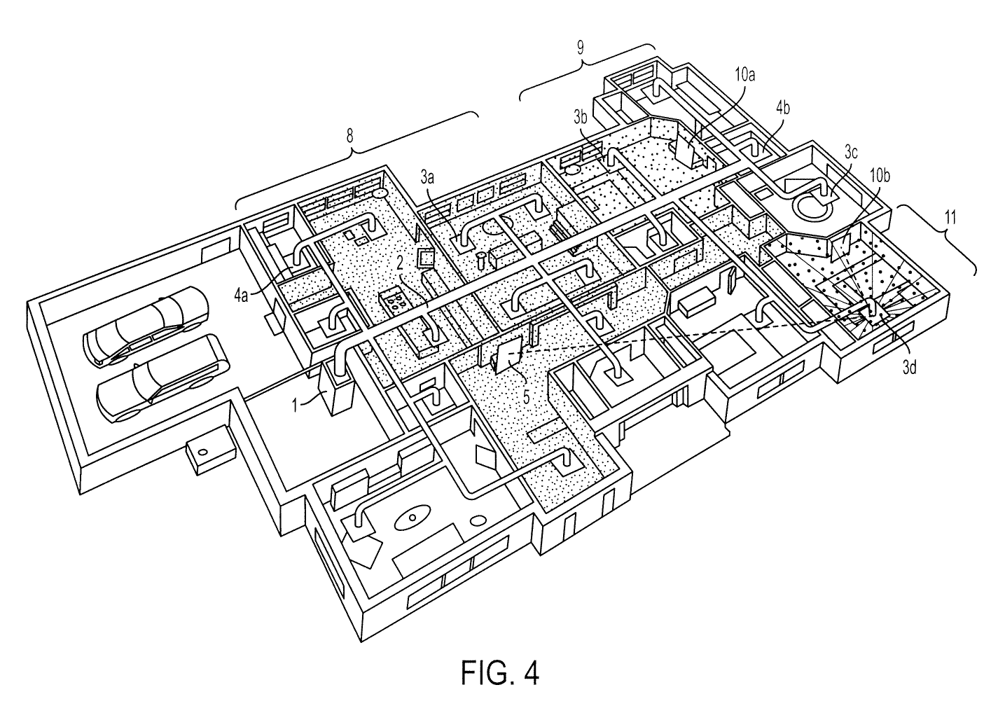

As shown in FIG. 4, the vent 3b in zone 2 9 closes once the selected temperature of 72° is reached. However, a remote thermostat 10b in a room in zone 3 11 instructs the system to stay on, because the remote thermostat 10b is set at 69°. The air from the air handler 1 passes quickly through the duct work 2 to zone 3 11, because the vents 3a in zone 1 8 are now closed in addition to the vents 3b in zone 2 9. The vent 3d in zone 3 11 remains open until zone 3 11 reaches the selected temperature. As is the case with most existing systems there may be a need for a discharge zones. The discharge zones 4a and 4b provide the necessary release for excess air back flow created when several vents 3a, 3b, 3c and 3d close at once. Small rooms are ideal for the discharge zones 4a and 4b. For example, discharge zones 4a and 4b can be small bathrooms, utility closets, laundry rooms, and hallways.

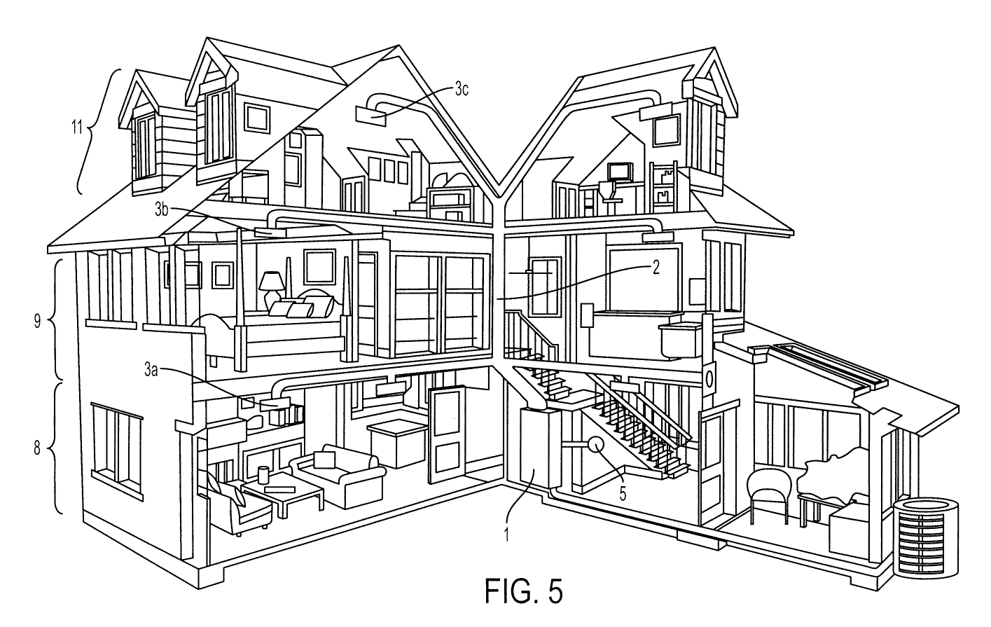

FIG. 5 is a perspective view of the system in a three story home as shown by way of a floor plan. The air handler 1 is connected to duct work 2 which carries the cooled or heated air to each room and up to the second and third floor. The air enters the rooms by vents 3a, 3b and 3c. The master thermostat 5 allows a user to select a temperature and other settings of the air handler 1. The system may include discharge zone 4a to discharge excess air pressure when several vents shut simultaneously. The airflow system allows the home to be divided into separate climate zones 8, 9 and 11. Accordingly, the individuals in the home only use the air needed, when and where it is required.

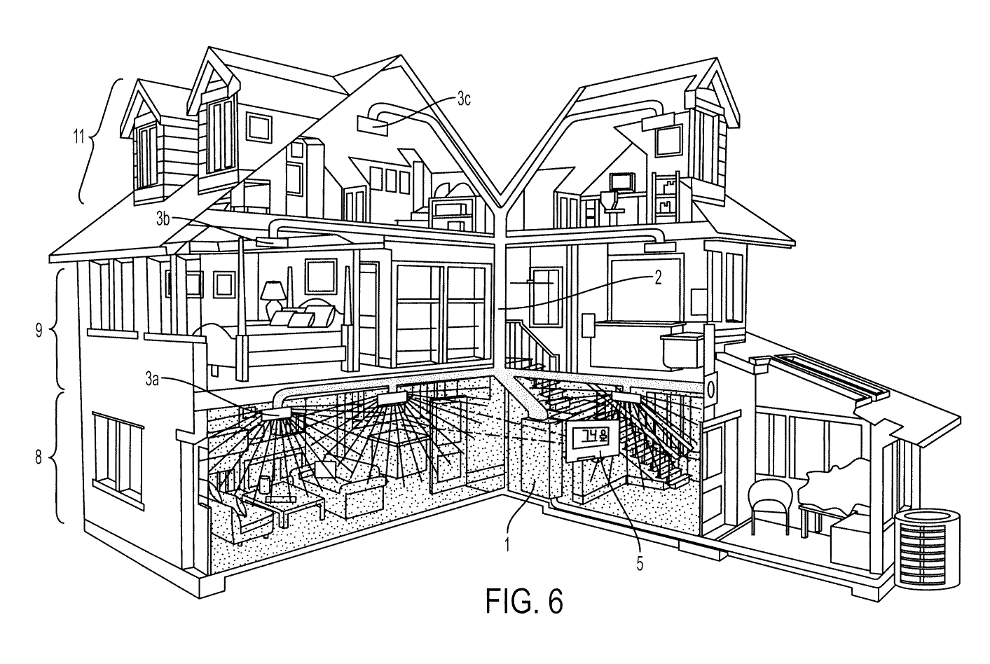

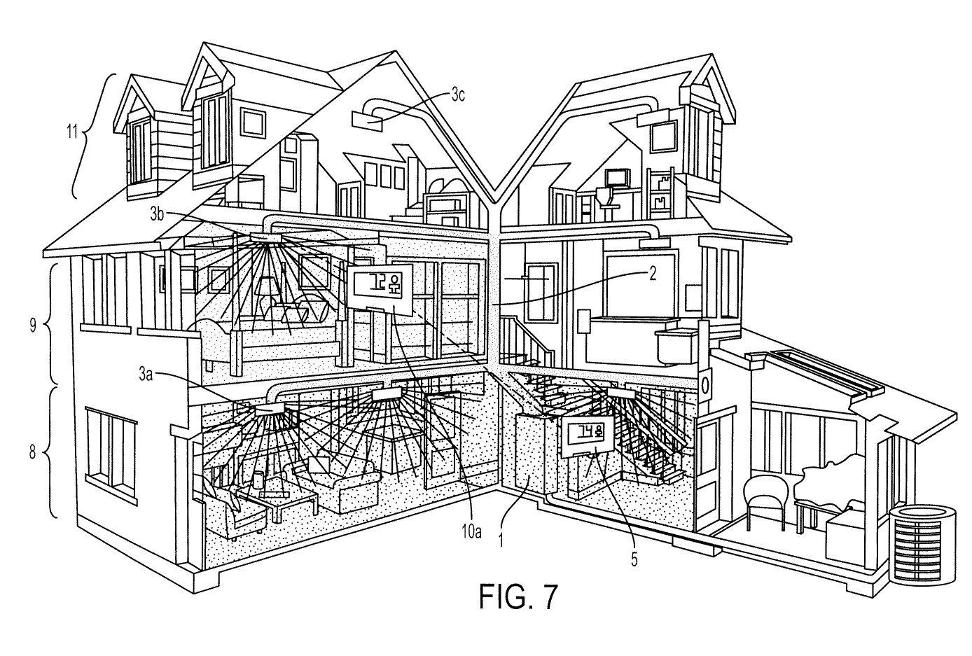

FIGS. 6, 7, and 8 demonstrate the airflow system by way of exemplary use of an embodiment of the system. As shown in FIG. 6, the individuals in the home can set the master thermostat 5 in zone 1 8 at 74°. The thermostat then communicates to all the vents 3a in zone 1 8 as to whether the vents should be open or closed to reach the desired temperature. In the next step, as shown in FIG. 7, the selected temperature is reached in zone 1 8. At that point, the vents 3a in zone 1 8 close. However, a remote thermostat 10a in a room in zone 2 9 instructs the system to stay on, because the remote thermostat 10a is set at 72°. The air from the air handler 1 passes quickly through the duct work 2 to zone 2 9, because the vents 3a in zone 1 8 are now closed. The vent 3b in zone 2 9 remains open until zone 2 9 reaches the selected temperature.

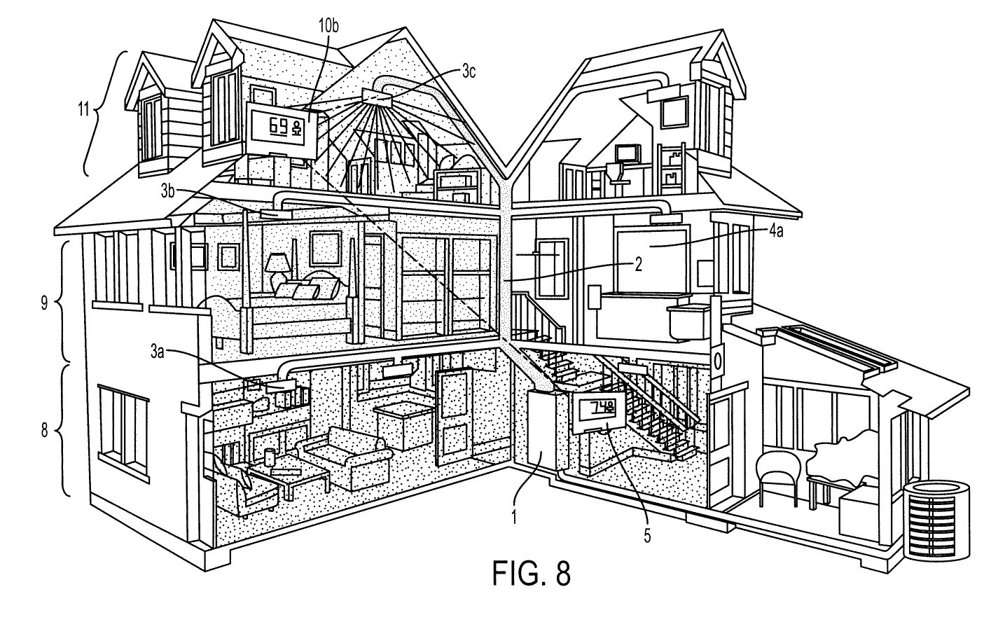

As shown in FIG. 8, the vent 3b in zone 2 9 closes once the selected temperature is reached. However, a remote thermostat 10b in a room in zone 3 11 instructs the system to stay on, because the remote thermostat 10b is set at 69°. The air from the air handler 1 passes quickly through the duct work 2 to zone 3 11, because the vents 3a in zone 1 8 are now closed in addition to the vents 3b in zone 2 9. The vent 3c in zone 3 11 remains open until zone 3 11 reaches the selected temperature. Some systems will require discharge zones. The discharge zone 4a provides the necessary release for excess air back flow created when several vents 3a, 3b and 3c close at once. Small rooms are ideal for the discharge zone 4a. For example, the discharge zone 4a can be small bathrooms, utility closets, laundry rooms, and hallways.

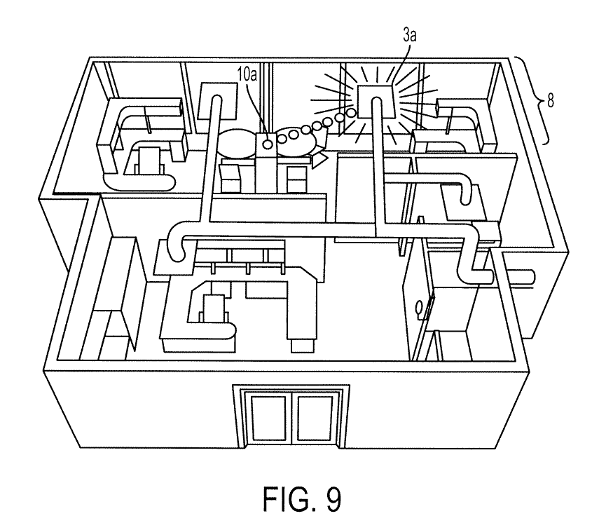

FIG. 9 is a perspective view of a single zone system. The floor plan shows a section of a building, which is depicted to be an office within the building. The air handler is an existing air handler controlled by the building. The vent 3a is a special vent that is capable of receiving signals from a remote thermostat 10a and opening and closing in response to the signal received. The remote thermostat 10a is used within a designated zone 8 of the office, which is a particular room of the office. The occupant of the designated zone 8 selects the desired temperature on the remote thermostat 10a and the remote thermostat 10a sends a wireless signal to the vent 3a to open or close depending upon the selected temperature. This single zone system controls the airflow to regulate the temperature irrespective of the existing thermostat that regulates the temperature of the building. Accordingly, all that is required to be able to modify the temperature of a single, designated zone within a office of a building is a vent 3a and remote thermostat 10a. The system does not require the vent 3a or remote thermostat 10a to be hardwired, which saves considerable costs on installing and using the system. The single zone system is optimal for areas of an office that are not frequently used, such as a conference room.

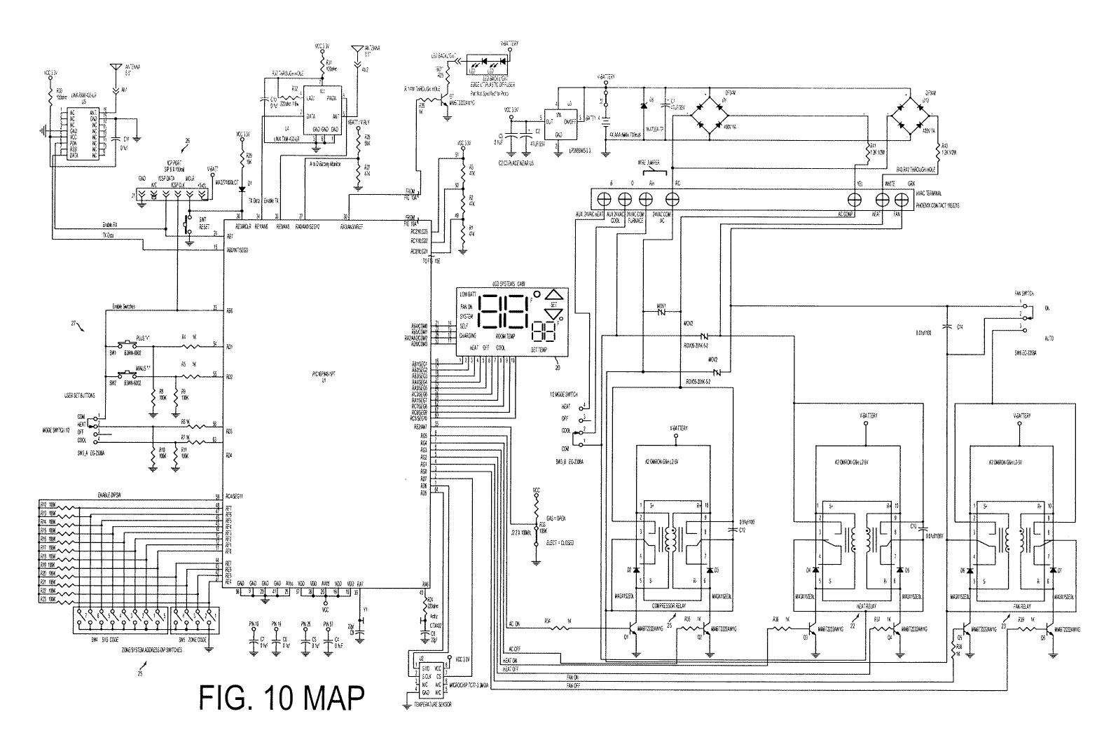

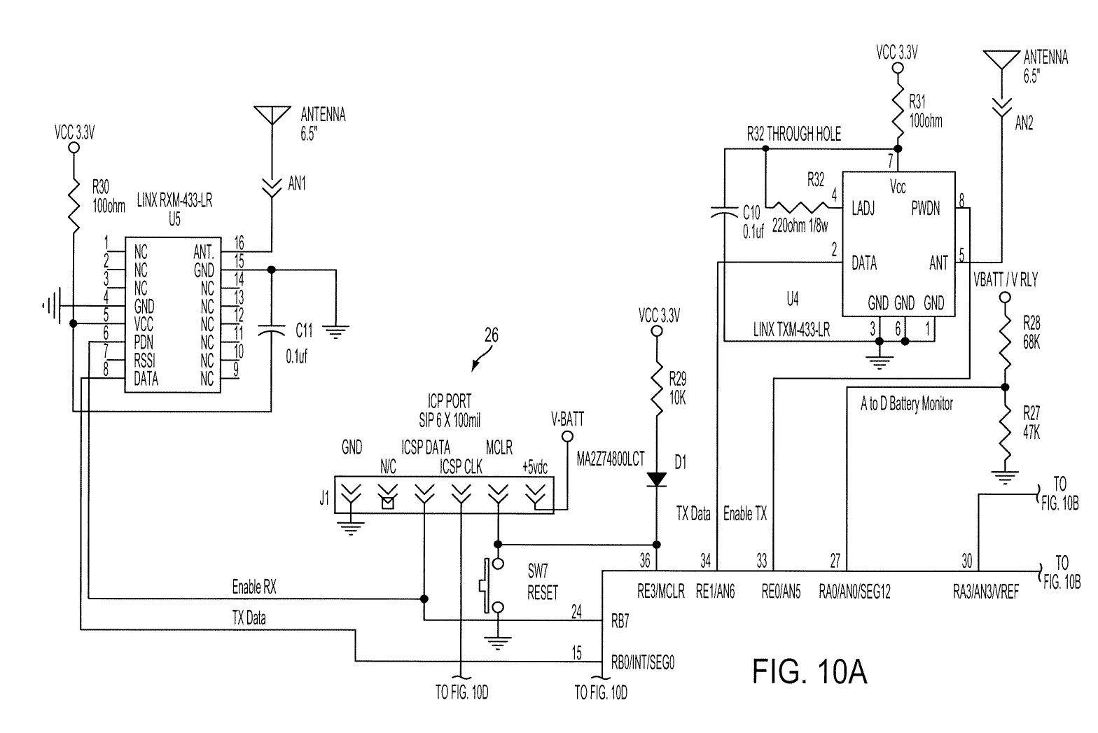

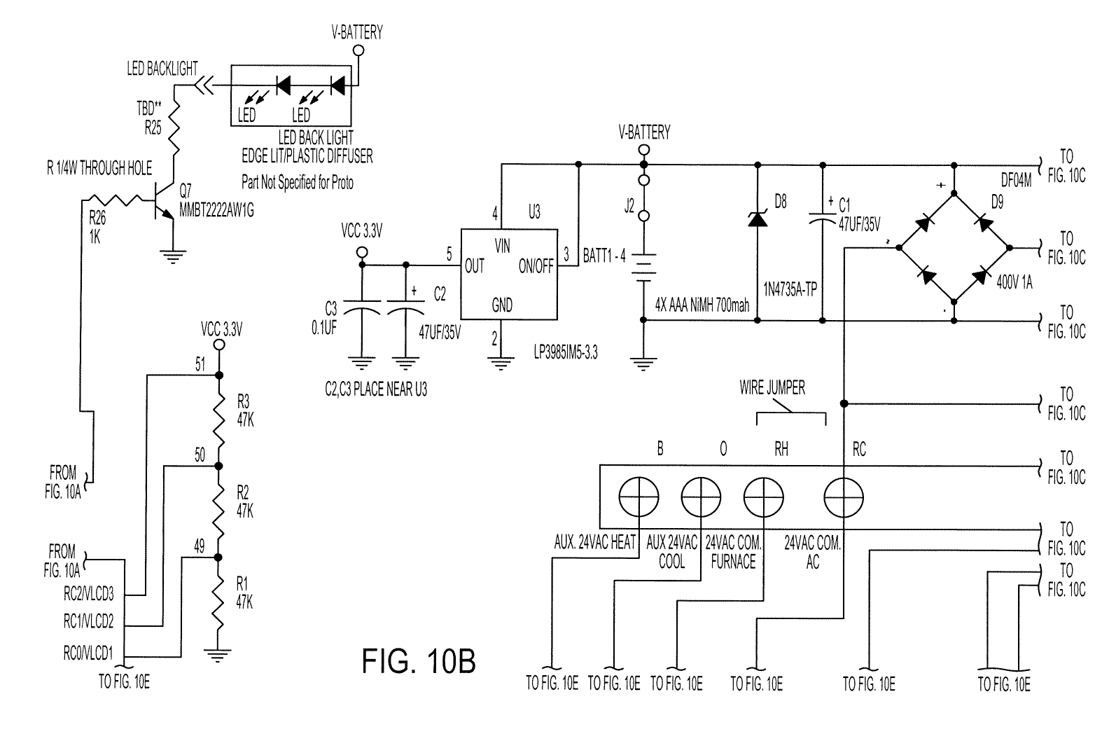

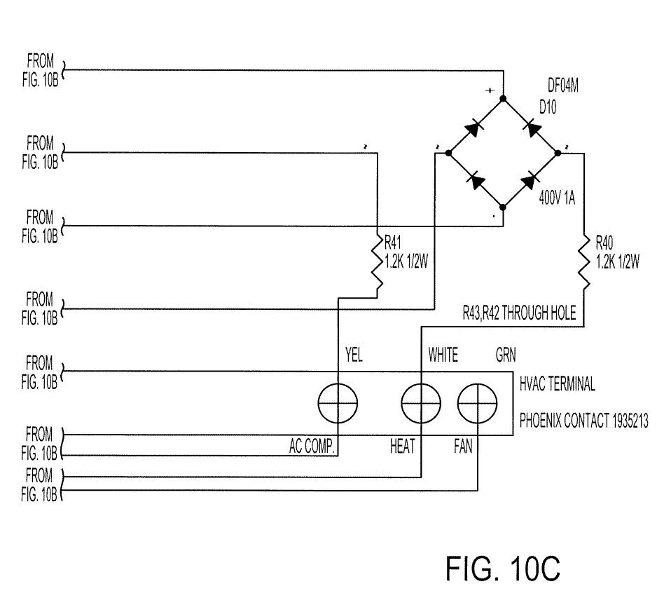

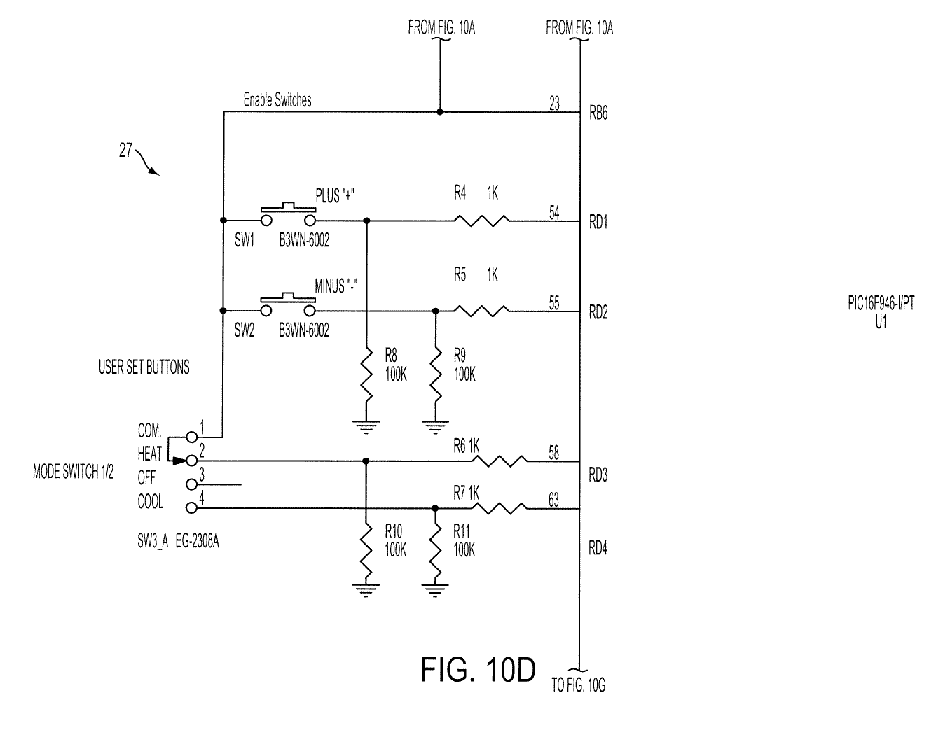

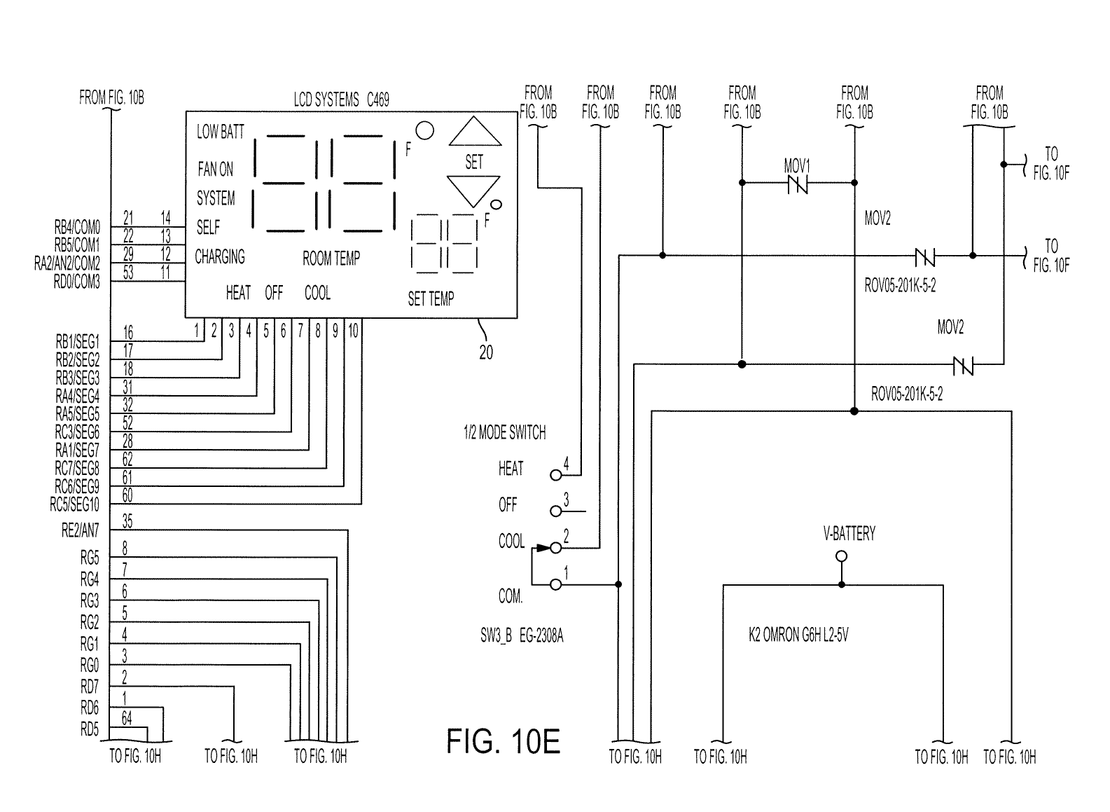

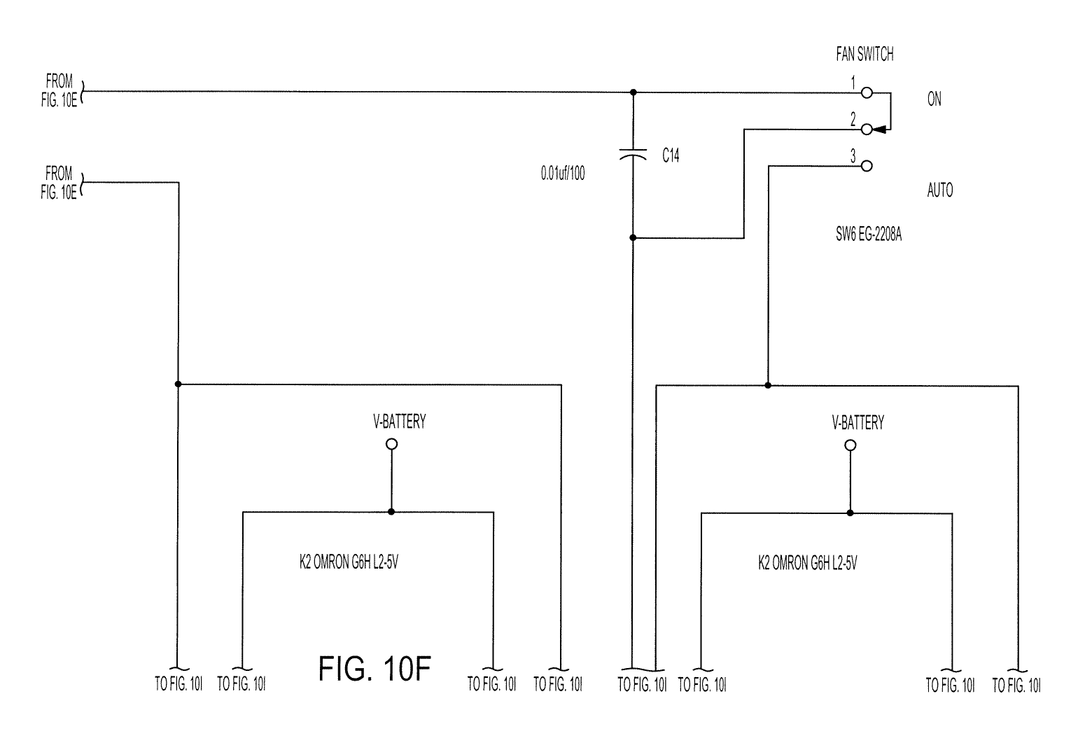

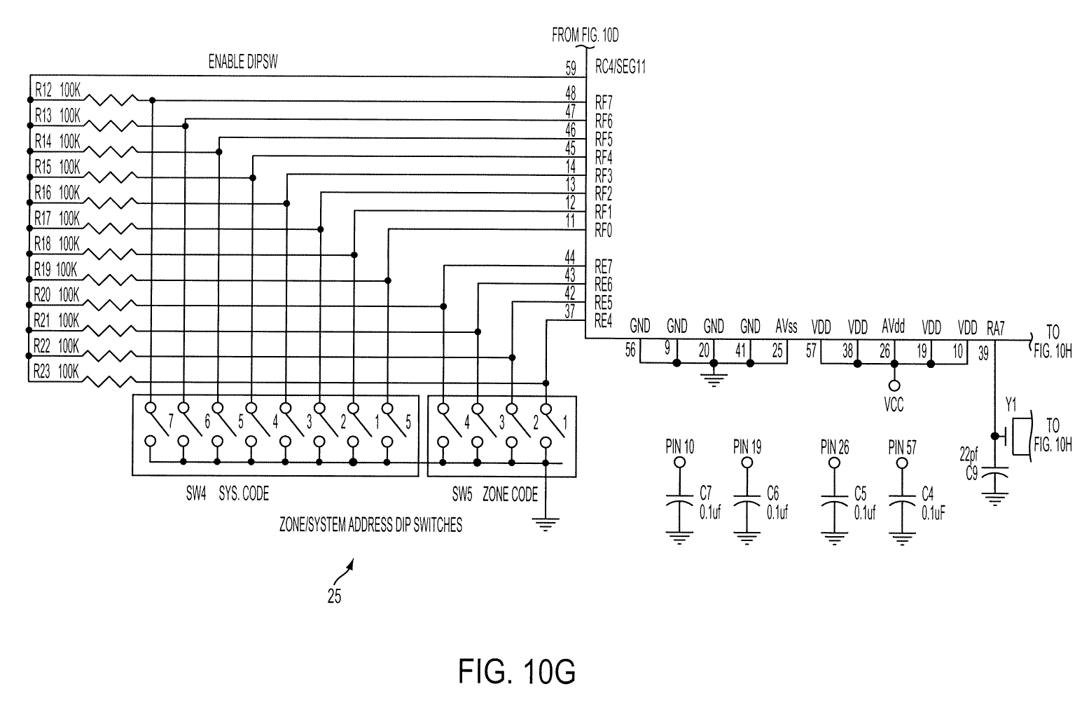

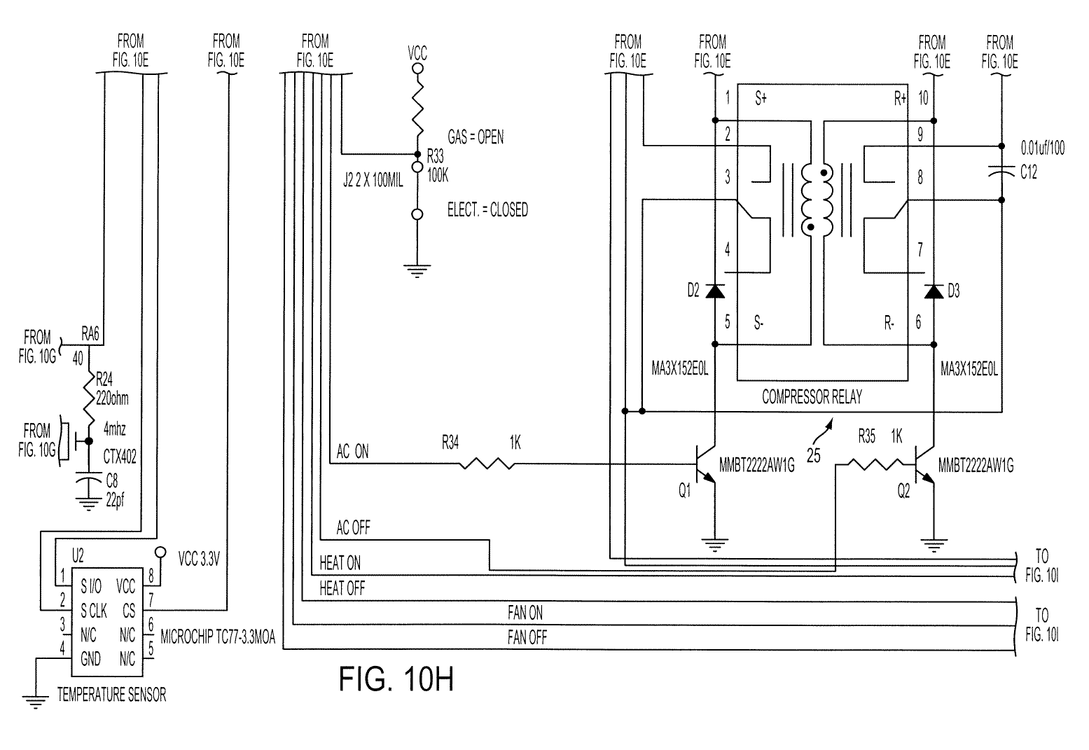

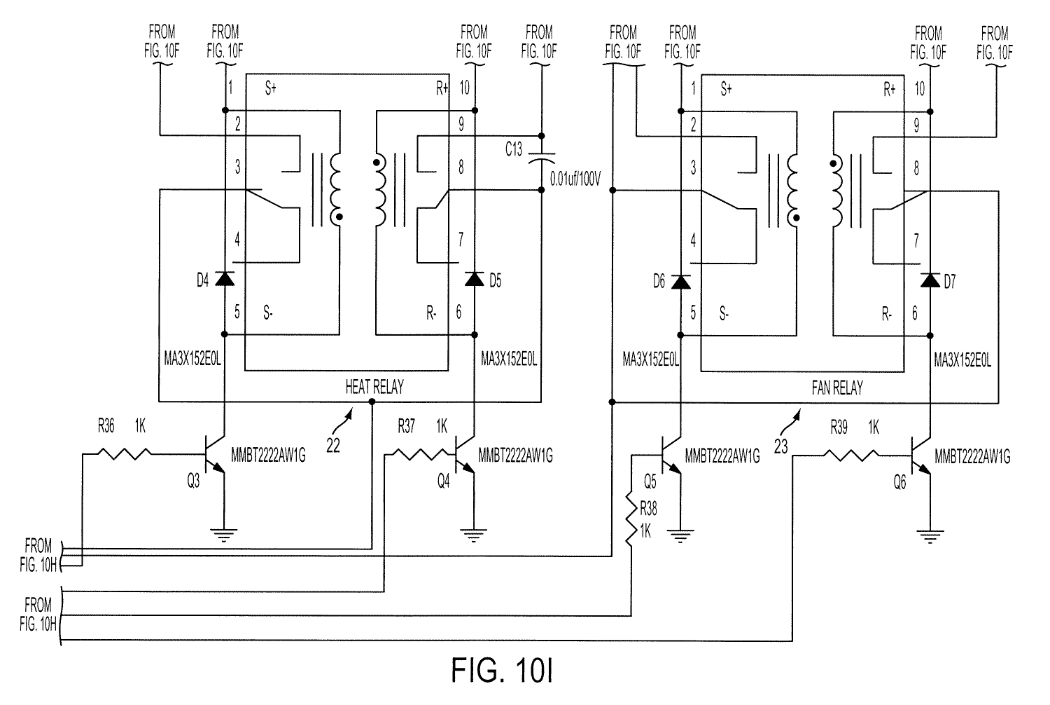

FIG. 10 is a schematic of the master thermostat. The master thermostat generally includes an LCD display 20, a compressor relay 21 that controls the condensing unit, a heat relay 22, a fan relay 23, a microchip 24 for sensing the temperature, zone system address switches 25, and user set buttons 27. The master thermostat performs all the functions of a conventional thermostat. Additionally, it has the ability to communicate with the vents sending instructions to open or close, it can receive communication from the remote thermostats, and it can create multiple zones.

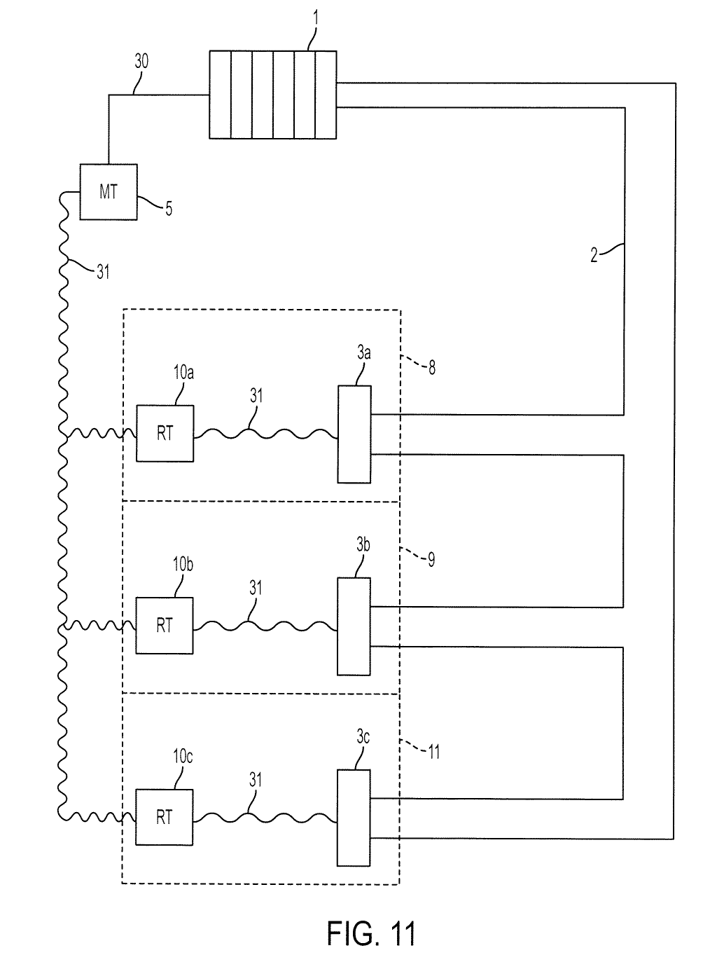

FIG. 11 is a schematic representation of interconnections between components of a multiple zone system. Shown is the air handler 1 connected to duct work 2 which carries the cooled or heated air to each designated zone 8, 9 and 11. The cooled or heated air exits the duct work 2 into each designated zone 8, 9 and 11 by vents 3a, 3b and 3c. The master thermostat 5 may be connected to the air handler 1 through an existing wired connection 30. The master thermostat 5 can control vents 3 through transmission of a wireless signal 31. Vents 3 are in the designated zone controlled by the master thermostat 5. The master thermostat 5 sends a wireless signal 31 to vents 3 to control the temperature of the designated zone by instructing the vents to open or close. The remote thermostats 10a, 10b and 10c communicate to the master thermostat 5 through wireless connection 31. The remote thermostats 10a, 10b, and 10c also communicate to vents 3a, 3b and 3c through transmission of a wireless signal 31. The remote thermostat 10a sends a wireless signal 31 to vent 3a to control the temperature of designated zone 1 8 by instructing the vent to open or close. The remote thermostat 10a also communicates with the master thermostat 5 through a wireless signal 31 if it is necessary to instruct the air handler to continue to run. The remote thermostat 10b sends a wireless signal 31 to vent 3b to control the temperature of designated zone 2 9 by instructing the vent to open or close. The remote thermostat 10b also communicates with the master thermostat 5 through a wireless signal 31 if it is necessary to instruct the air handler to continue to run. The remote thermostat 10c sends a wireless signal 31 to vent 3c to control the temperature of designated zone 3 11 by instructing the vent to open or close. The remote thermostat 10c also communicates with the master thermostat 5 through a wireless signal 31 if it is necessary to instruct the air handler to continue to run.

Accordingly, it will be understood that the preferred embodiment of the present invention has been disclosed by way of example and that other modifications and alterations may occur to those skilled in the art without departing from the scope and spirit of the appended claims.

What is claimed is:

1. A climate zone controlling system that controls an air handler connected to duct work that distributes air to rooms of a building through at least one vent comprising:
a master thermostat that controls the temperature of said air exiting said air handler; and
at least one remote thermostat that controls the temperature of at least one designated zone of the building, wherein said remote thermostat is located in said designated zone and directs the at least one vent in said designated zone to open or close through transmission of a wireless signal so that the designated zone reaches the temperature selected by a user of said remote thermostat, and wherein the remote thermostat communicates with said master thermostat through transmission of a wireless signal when the air handler is required to remain on to reach said selected temperature.

2. The climate zone controlling system of claim 1, wherein the master thermostat directs the at least one vent within the designated zone of the master thermostat to open and close.

3. The climate zone controlling system of claim 1, wherein said designated zone of a building includes one or more rooms of the building.

4. The climate zone controlling system of claim 1, wherein the at least one remote thermostat is battery operated and wireless.

5. The climate zone controlling system of claim 1, wherein the master thermostat and the at least one remote thermostat each communicates on a unique channel.

6. A climate zone controlling system that controls the temperature of designated zones by a wireless signal comprising:
an existing thermostat that controls the temperature of air exiting an air handler; and
at least one remote thermostat that controls the temperature of at least one designated zone of the building, wherein said remote thermostat is located in said designated zone and directs at least one vent in said designated zone to open or close through a wireless signal so that the designated zone reaches the temperature selected by a user of the remote thermostat through control of airflow.

7. The climate zone controlling system of claim 6, wherein said designated zone of a building includes one or more rooms of the building.

8. The climate zone controlling system of claim 6, wherein the at least one remote thermostat is battery operated and wireless.

9. A method of modifying the temperature of designated zones in a building comprising the steps of:
setting a master thermostat at a first desired temperature, wherein said master thermostat controls the air handler of said building and at least one vent in a first designated zone of the building; and
setting a remote thermostat at a second desired temperature, wherein said remote thermostat is located in a second designated zone of the building and controls the at least one vent in said second designated zone by directing the at least one vent to open or close through the transmission of a wireless signal in order to obtain the second desired temperature, and wherein multiple remote thermostats may be used to control the temperature of multiple respective designated zones of the building.

10. The method of claim 9, wherein said designated zone of a building comprises one or more rooms of the building.

11. The method of claim 9, wherein two or more remote thermostats are used to control two or more designated zones within the building, whereby each remote thermostat controls one respective designated zone within the building.

12. The method of claim 9, wherein the remote thermostat communicates with said master thermostat through a wireless signal when said air handler is required to remain on to reach said second desired temperature.

13. The method of claim 9, wherein the remote thermostat is battery operated and wireless.

14. A method of modifying the temperature of designated zones in a building by controlling airflow from an air handler comprising the steps of:
setting an existing thermostat at a first desired temperature, wherein said existing thermostat controls the air handler of said building; and
setting a remote thermostat at a second desired temperature, wherein said remote thermostat is located in a designated zone of the building and controls at least one vent in said designated zone by directing the at least one vent to open or close through transmission of a wireless signal in order to obtain the second desired temperature through control of airflow to said designated zone and wherein multiple remote thermostats may be used to control the temperature of multiple respective designated zones of the building.

15. The method of claim 14, wherein said designated zone of a building comprises one or more rooms of the building.

16. The method of claim 14, wherein two or more remote thermostats are used to control two or more designated zones within the building, whereby each remote thermostat controls one respective designated zone within the building.

17. A single zone climate controlling system that controls an air handler comprising:
a existing thermostat that controls the temperature of the air exiting the air handler; and
a remote thermostat that controls the temperature of the single zone of a building, wherein said remote thermostat is located in said single zone and directs at least one vent in said single zone to open or close through transmission of a wireless signal so that the single zone reaches the temperature selected by a user of the remote thermostat through control of the airflow.

18. The single zone climate controlling system of claim 17, wherein the remote thermostat is battery operated and wireless.

19. A multiple zone climate controlling system that controls an air handler comprising:
a master thermostat that controls the temperature of the air and directs at least one vent to open and close within a first designated zone; and
at least one remote thermostat that controls the temperature of a second designated zone in said multiple zones wherein said remote thermostat is located in said second designated zone and directs the at least one vent in said second designated zone to open or close through transmission of a wireless signal so that the second designated zone reaches the temperature selected by a user of the remote thermostat, and wherein the remote thermostat communicates with said master thermostat through transmission of a wireless signal when the air handler is required to remain on to reach said selected temperature.

20. The multiple zone climate controlling system of claim 19, wherein when the temperature of a first designated zone is reached, the remote thermostat directs the at least one vent to close and the air is directed to the remaining designated zones of said multiple zones.

21. The multiple zone climate controlling system of claim 19, wherein the at least one remote thermostat is battery operated and wireless.
